(19) United States
(12) Patent Application Publication
(10) Pub. No.: US 2012/0116640 A1
(43) Pub. Date: May 10, 2012

(54) SYSTEM FOR TRACKING A STOLEN-VEHICLE AND METHOD THEREOF

(75) Inventors: Chi Nam Oh, Suwon (KR); Jong Moon Kim, Seoul (KR)

(73) Assignees: KIA MOTORS CORPORATION, Seoul (KR); HYUNDAI MOTOR COMPANY, Seoul (KR)

(21) Appl. No.: 13/041,873

(22) Filed: Mar. 7, 2011

(30) Foreign Application Priority Data
Nov. 9, 2010 (KR) 10-2010-0111059

(51) Int. Cl. G06F 19/00

(52) U.S. Cl. 701/70

(57) ABSTRACT

The present invention provides a system for tracking a stolen vehicle, which includes a vehicle terminal configured to generate a periodic signal according to a given time period; and a control unit configured to determine whether the vehicle terminal is broken or out of place based on whether or not the periodic signal has been generated within the given time period, and when the vehicle terminal is determined to be broken or out of place, configured to stop or slow down the vehicle.

### CROSS-REFERENCES TO RELATED APPLICATIONS

This patent application claims priority to Korean Patent Application Number 10-2010-0111059, filed on Nov. 9, 2010 which is hereby incorporated by reference in its entirety.

### BACKGROUND OF THE INVENTION

1. Field of the Invention

The present invention relates to a method and a system for tracking a stolen vehicle, and more particularly, to a technology for preventing a vehicle theft and tracking a location of the stolen vehicle.

2. Description of the Related Art

As civilization advances, vehicles have become more widely used as the primary means of transportation. At the same time, the number of vehicle thefts is also increased accordingly.

Conventionally, in order to prevent car theft, a car alarm has been used to set off an alarm sound upon detecting an attempted vehicle theft.

However, in the conventional technology, only those who are near the car and thus can hear the alarm sound can recognize that a theft is being committed. Once, however, the stolen vehicle is moved to another place, it is very difficult to locate the vehicle. When this happens, it may take a long time to recover the stolen vehicle utilizing conventional methods such as for example, tracking the lost vehicle based on a license plate, model and color thereof.

### SUMMARY OF THE INVENTION

The present invention provides a method and an apparatus for detecting a vehicle theft and tracking a stolen vehicle with increased efficiency and accuracy.

In accordance with one aspect of the present invention, a system is provided for tracking a stolen vehicle, which includes a vehicle terminal configured to generate a periodic signal over a given time period. This aspect of the present invention also includes a control unit configured to determine whether the vehicle terminal is broken or has been moved based on whether or not the periodic signal has been generated, and when the vehicle terminal is determined to be broken or moved, configured to stop or slow down the vehicle.

In accordance with another aspect of the present invention, a system for tracking a stolen vehicle may also include a display unit that is configured to display a pop up message of the vehicle being stopped or slowed down on a screen, when the vehicle is controlled to stop or slow down. More specifically, the control unit determines whether the vehicle terminal is broken or out of place by identifying whether a given period of time has elapsed from the time the last periodic signal was generated from the vehicle terminal.

In accordance with another aspect of the present invention, the system for tracking a stolen vehicle may also include a vehicle information center that is configured to communicate with the stolen vehicle upon receiving a stolen vehicle tracking request from a user. By configuring the vehicle information center to communicate with the stolen vehicle, the system is able to detect various location information associated with the stolen vehicle The detected location information is then transmitted to the police, and the vehicle is configured to stop or slow down upon receiving a vehicle stop command or a vehicle slow down command from the vehicle information center. The vehicle information center may then perform a handover to a different network depending on a network condition, when communicating with the vehicle or the police. The vehicle information center may also perform the handover to Wireless Broadband (WiBro) or WiFi to communicate with the vehicle or the police, when a mobile communication network has a weak transmission and reception. The vehicle information center may also submit a request to cancel the vehicle stop command or the vehicle slow down command directed to the vehicle when the police are notified that a tracking of the stolen vehicle has been completed. The vehicle information center may also notify the user of the location information of the stolen vehicle or a tracking result by using either an email, a short message service (SMS), a multimedia messaging service (MMS), a phone call, or a website.

The vehicle in the present invention may include: a vehicle terminal configured to communicate with the vehicle information center; a control unit configured to stop or slow down the vehicle according to the vehicle stop command or the vehicle slow down command received through the vehicle terminal; and a display unit configured to display a first pop up message to the person in the vehicle being stopped or slowed down or a second pop up message indicating a cancellation of the vehicle stop command or the vehicle slow down command.

In accordance with another aspect of the present invention, a method is provided for tracking a stolen vehicle. Initially, it is determined whether a given period of time has elapsed since the last time a signal was generated from a vehicle terminal. In response to a determination that this specific amount of time has elapse, it is determined by the control unit that the vehicle terminal has been broken or is out of place. When the control unit determines that the vehicle terminal has been broken or is out of place, a vehicle stop command or a vehicle slow down command is generated and the vehicle is stopped or slowed, respectively.

In accordance with another aspect of the present invention, the method of tracking a stolen vehicle may also include displaying a pop up message associated a result of performing the vehicle stop command or the vehicle slow down command on a screen disposed within the vehicle.

In accordance with another aspect of the present invention, the method of tracking a stolen vehicle may also include attempting, by a vehicle information center, to establish a first communication connection with the vehicle upon receiving a stolen vehicle tracking request over a first communication network, and then retrying a second communication connection via different communication networks when the first communication connection fails. Once a communication has been established, the vehicle information center may then receive location information associated with the stolen vehicle. The police may then be notified of the location of the vehicle based upon the location information provided over the established communication. A vehicle stop command or a vehicle slow down command may then be transmitted to the vehicle thereby stopping or slowing the stolen vehicle, respectively.

In accordance with another aspect of the present invention, a method of tracking a stolen vehicle further may also include sending a request to the stolen vehicle to cancel the vehicle stop command or the vehicle slow down command directed to the vehicle once the police have acquired the stolen vehicle.

In accordance with another aspect of the present invention, the method of tracking a stolen vehicle further may also display, on a screen disposed within the vehicle, a first pop up message indicating the vehicle has received a stop command or a vehicle slow down command. Additionally, a second pop up message indicating that the vehicle stop command or the vehicle slow down commands have respectively been cancelled. The vehicle information center may also notify the user of the location of the vehicle based on the location information received or a tracking result by using either an email, a short message service (SMS), a multimedia messaging service (MMS), a phone call, or a website.

### BRIEF DESCRIPTION OF THE DRAWINGS

The objects, features and advantages of the present invention will be more apparent from the following detailed description in conjunction with the accompanying drawings, in which:

FIG. 1 is a diagrammatic view illustrating a configuration of a system for tracking a stolen vehicle according to an exemplary embodiment of the present invention;

FIG. 2 is a flowchart diagram illustrating a method of preventing a vehicle theft according to an exemplary embodiment of the present invention;

FIG. 3 is a flowchart diagram illustrating a method of tracking a stolen vehicle according to an exemplary embodiment of the present invention;

FIG. 4 illustrates an example pop up message as illustrated in FIGS. 2 and 3; and

FIG. 5 is a view showing a handover situation as illustrated in FIG. 3.

### DETAILED DESCRIPTION OF EXEMPLARY EMBODIMENTS

Exemplary embodiments of the present invention are described with reference to the accompanying drawings in detail. The same reference numbers are used throughout the drawings to refer to the same or like parts. Detailed descriptions of well-known functions and structures incorporated herein may be omitted to avoid obscuring the subject matter of the present invention.

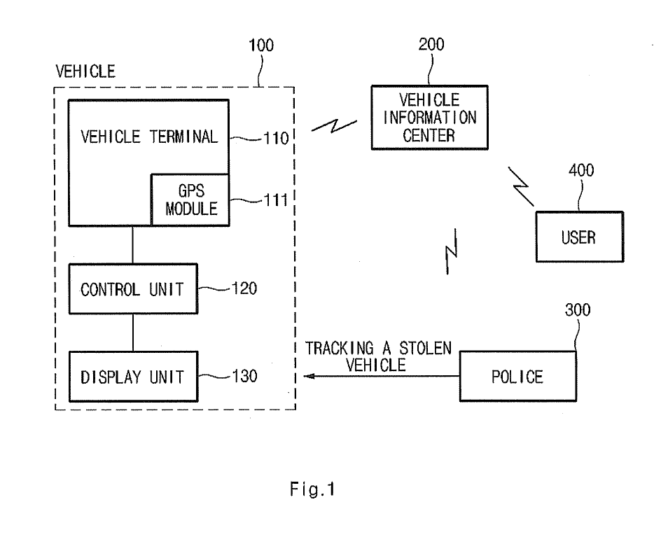

FIG. 1 is a diagrammatic view illustrating a configuration of a system for tracking a stolen vehicle according to an exemplary embodiment of the present invention.

The system for tracking a stolen vehicle may perform a wireless communication between a vehicle 100, a vehicle information center 200, police 300 and a user 400 in order to prevent a vehicle theft and enable tracking of the stolen vehicle.

Specifically, the vehicle 100 may perform a communication with the vehicle information center 200. To this end, the vehicle 100 includes a vehicle terminal 110, a control unit 120 and a display unit 130.

The vehicle terminal 110 may be configured to detect and provide the location of a stolen vehicle based on location information received by the vehicle information center 200. Additionally, upon receiving a stop/slow command from the vehicle information center 200, the stop/slow command is transmitted to the control unit 120. To this end, the vehicle terminal 110 may include a global positioning system (GPS) module 111 that detects the location information associated with the location of the vehicle in association with a GPS (not shown).

The vehicle terminal 110 may also be mounted within the vehicle to output a periodic signal to the control unit 120 at every given period.

The control unit 120 may then detect whether a particular signal is periodically outputted from the vehicle terminal 110 and whether a given period of time has elapsed since the last output of the particular signal. If it is determined that the given period of time has elapsed, the vehicle terminal 110 may be identified as being broken or out of place. Accordingly, when the vehicle terminal 110 is identified as being broken or out of place, the control unit 120 outputs a stop/slow command to the vehicle which may be in motion so that the vehicle may be stopped or slowed down, respectively.

When the stop/slow command is outputted from the control unit 120, the display unit 130 displays the contents of the stop/slow command in the form of, for example, a pop up message on a screen within the vehicle so that a driver can be notified that such a command has been received.

The vehicle information center 200 may perform a wireless communication with the vehicle 100 to receive the stolen vehicle's location information and transmit the location information of the vehicle to the police 300 and the user 400.

When the police 300 receive the location information of the vehicle from the vehicle information center 200, the police 300 may then physically track the vehicle and provide a tracking result to the vehicle information center 200.

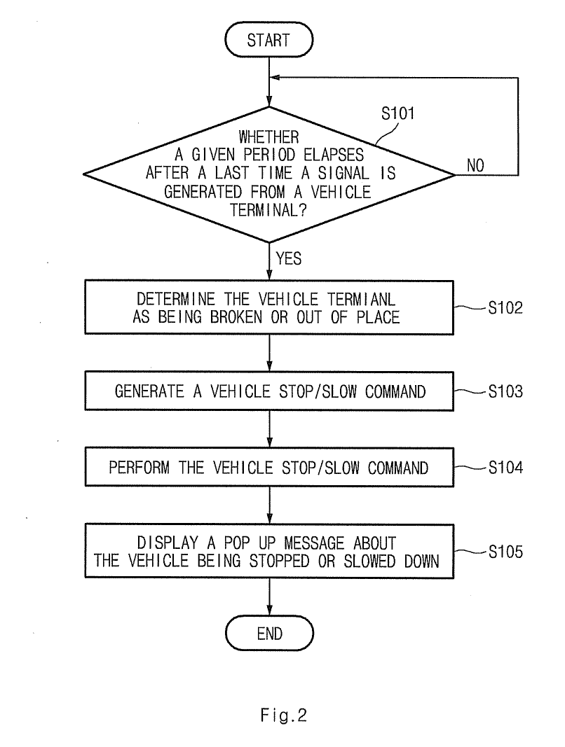

Hereinafter, a method of preventing a vehicle theft according to an exemplary embodiment is described in detail with reference to FIG. 2.

First, the control unit 120 monitors if a given period of time has elapsed since the last time a signal was generated from the vehicle terminal 110 (101) and, if the given period of time elapses, it is determined that the vehicle terminal 110 is broken or out of place (102), thereby indicating that the vehicle may have been stolen.

Next, the control unit 120 generates a stop/slow command for the stolen vehicle when the vehicle is in motion (103) so that the vehicle is stopped or slowed down (104).

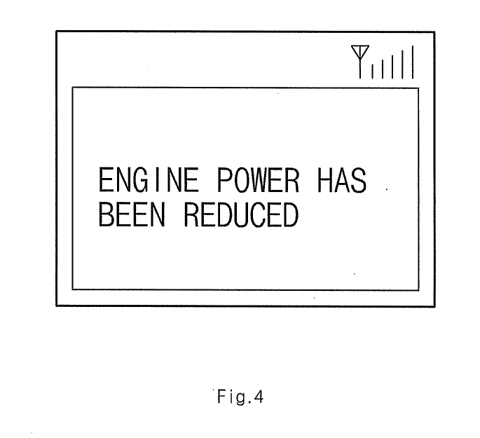

Next, the control unit 120, in association with the display unit 130, displays a popup message of the stop/slow command for the vehicle on the screen so that a driver may be notified that the vehicle has been stopped or slowed down (105) by the vehicle information center. Here, the display unit 130 may display the popup message on the screen as illustrated in FIG. 4.

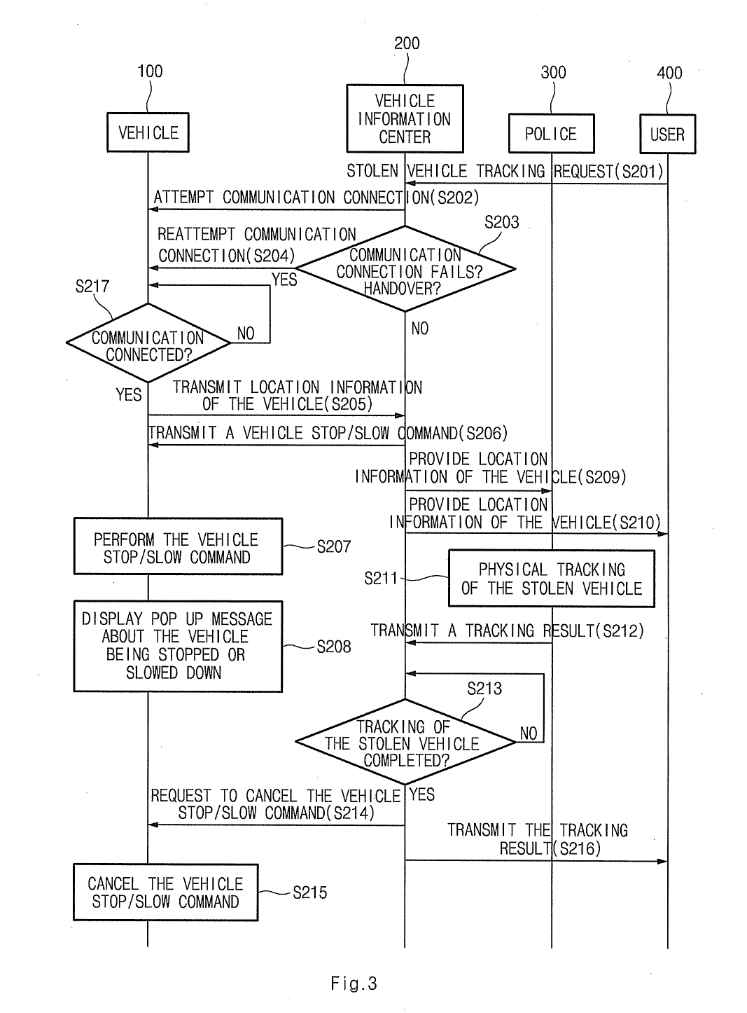

Hereinafter, a method of tracking a stolen vehicle that has been implemented by a user according to an exemplary embodiment of the present invention will be described with reference to FIG. 3.

First, when a vehicle information center 200 receives a stolen vehicle tracking request from a user 400 (201), the vehicle information center 200 attempts to establish a communication connection with the vehicle terminal 110 that is mounted within the vehicle 100 (i.e., the stolen vehicle) (202). If the connection attempt fails (203), the vehicle information center 200 retries the communication connection via any other communication network (204) it has available.

Upon the communication connection being established (217), the location information of the vehicle 100 detected by the GPS module 111 and is transmitted to the vehicle information center 200 (S205).

The vehicle information center 200 then transmits the stop/slow command to the vehicle 100 (206) and the control unit 120 may perform a stop/slow command of the vehicle 100 (207). Next, the display unit 130 may display on a screen within the vehicle a popup message containing the stop/slow command of the vehicle that has been transmitted to the car or is being performed (208).

Meanwhile, the vehicle information center 200 may also transmit the location information of the vehicle 100 received from the vehicle terminal 110 to both the police 300 and the user 400 (209, 210), and the police 300 may physically track the vehicle 100 (211). Here, the vehicle information center 200 notifies the user 400 of the location of the stolen vehicle based upon the location information received and a tracking result may be obtained by the user by using either an email, a short message service (SMS), a multimedia messaging service (MMS), a phone call, etc. Also, the user 400 may connect to a website provided by the vehicle information center 200 over an internet network to monitor the location and the tracking results of the stolen vehicle.

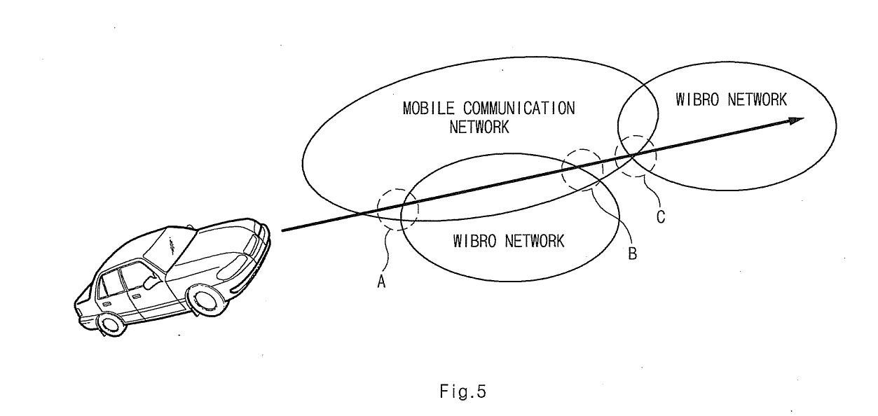

Next, when the vehicle information center 200 receives the tracking result of the stolen vehicle from the police 300 (212), it is determined whether the tracking of the stolen vehicle has been completed (213). When the tracking of the stolen vehicle has been completed, the vehicle information center 200 may then send a request to cancel the stop/slow command of the vehicle 100 (214). Accordingly, the vehicle 100 is released from the vehicle stop/slow command (215). With reference to FIG. 5, a handover situation in steps 202 through 204 is described. When, by default, the vehicle information center 200 and the vehicle 100 are set up to use a mobile communication network, for example, a 3G network, and the vehicle 100 enters to an area having a weak signal strength or a heavy traffic area, the vehicle information center 200 searches for other communication networks such as Wireless Broadband (WiBro) or WiFi, which may be located in a corresponding area, and transfers calls to the other communication network such as WiBro or WiFi having a stronger signal reception at a handover point A, B, or C.

To this end, it is preferable that the vehicle terminal 110 includes not only a module for a mobile communication network connection but also a module for any other communication networks such as WiBro or WiFi.

Advantageously, the present invention utilizes a handover technique to connect/interlock different communication networks so that, when one communication network has a poor signal reception, a handover between multiple communication networks can occur to provide a continuity and enhanced quality of communication services in an anti-theft system of a stolen vehicle. Accordingly, vehicle theft can be prevented and the recovery success rate of a stolen vehicle tracking process can be increased.

Although exemplary embodiments of the present invention have been described in detail hereinabove, it should be clearly understood that many variations and modifications of the basic inventive concepts herein taught which may appear to those skilled in the present art will still fall within the spirit and scope of the present invention, as defined in the appended claims.

What is claimed is:

1. A system for tracking a stolen vehicle, the system comprising:
a vehicle terminal configured to generate a periodic signal according to a given time period; and
a control unit configured to determine whether the vehicle terminal is broken or out of place based on whether or not the periodic signal is generated, and when the vehicle terminal is determined to be broken or out of place, configured to stop or slow down the vehicle.

2. The system of claim 1, further comprising:
a display unit configured to display a pop up message of the vehicle being stopped or slowed down on a screen when the vehicle is controlled to stop or slow down.

3. The system of claim 1, wherein the control unit determines whether the vehicle terminal is broken or out of place by identifying whether a given period of time elapses after a last time the periodic signal is generated from the vehicle terminal.

4. The system of claim 2, wherein the control unit determines whether the vehicle terminal is broken or out of place by identifying whether a given period of time elapses after a last time the periodic signal is generated from the vehicle terminal.

5. A system for tracking a stolen vehicle, the system comprising:
a vehicle information center configured to communicate with the stolen vehicle upon receiving a stolen vehicle tracking request from a user, the vehicle information center configured to detect and receive location information of the stolen vehicle, and configured to transmit the detected location information to police; and
a vehicle configured to stop or slow down upon receiving a vehicle stop command or a vehicle slow down command from the vehicle information center, wherein the vehicle information center performs a handover to a different network depending on a network condition, when communicating with the vehicle or the police.

6. The system of claim 5, wherein the vehicle information center performs the handover to Wireless Broadband (WiBro) or WiFi to communicate with the vehicle or the police, when a mobile communication network has a weak transmission and reception.

7. The system of claim 5, wherein the vehicle information center requests to cancel the vehicle stop command or the vehicle slow down command directed to the vehicle when the police notifies that a tracking of the stolen vehicle is completed.

8. The system of claim 5, wherein the vehicle information center notifies the user of the location information of the stolen vehicle or a tracking result by using at least one of an email, a short message service (SMS), a multimedia messaging service (MMS), a phone call, or a website.

9. The system of claim 7, wherein the vehicle comprises:
a vehicle terminal configured to communicate with the vehicle information center;
a control unit configured to stop or slow down the vehicle according to the vehicle stop command or the vehicle slow down command received through the vehicle terminal; and
a display unit configured to display a first pop up message about the vehicle being stopped or slowed down or a second pop up message about a cancellation of the vehicle stop command or the vehicle slow down command.

10. A method of tracking a stolen vehicle, the method comprising:
determining whether a given period of time has elapsed since a last time a signal was generated from a vehicle terminal;
determining the vehicle terminal is broken or out of place when the given period of time has elapsed, and generating a vehicle stop command or a vehicle slow down command; and
stopping or slowing down the stolen vehicle according to the vehicle stop command or the vehicle slow down command.

11. The method of claim 10, further comprising:
displaying a pop up message upon performing the vehicle stop command or the vehicle slow down command on a screen.

12. A method of tracking a stolen vehicle, the method comprising:
attempting, by a vehicle information center, to establish a first communication connection with the vehicle upon receiving a stolen vehicle tracking request, and retrying a second communication connection via other communication network when the first communication connection fails;
receiving location information of the stolen vehicle from the stolen vehicle if the first or second communication connection is established;
notifying police of the location information of the stolen vehicle;
transmitting a vehicle stop command or a vehicle slow down command to the stolen vehicle; and
performing, by the vehicle, the vehicle stop command or the vehicle slow down command.

13. The method of claim 12, further comprising:
requesting to cancel the vehicle stop command or the vehicle slow down command directed to the stolen vehicle when the police notifies vehicle information center that a tracking of the stolen vehicle has been completed.

14. The method of claim 13, further comprising:
displaying, on a screen, a first pop up message about a result of performing the vehicle stop command or the vehicle slow down command or a second pop up message about a cancellation of the vehicle stop command or the vehicle slow down command.

15. The method of claim 12, wherein the vehicle information center notifies the user of the location information of the vehicle or a tracking result by using at least one of an email, a short message service (SMS), a multimedia messaging service (MMS), a phone call, or a website.
